(19) United States
(12) Patent Application Publication
(10) Pub. No.: US 2026/0126042 A1
(43) Pub. Date: May 7, 2026

(54) SCROLL COMPRESSOR

(71) Applicant: Ausserer GmbH, Dornbirn (AT)

(72) Inventor: Florian Karl AUSSERER, Dornbirn (AT)

(73) Assignee: Ausserer GmbH, Dornbirn (AT)

(21) Appl. No.: 19/118,847

(22) PCT Filed: Oct. 25, 2022
(86) PCT No.: PCT/AT2022/000014

§ 371 Date: Apr. 7, 2025

(51) Int. Cl. F04C 18/02; F04C 27/00

(52) U.S. Cl. CPC F04C 18/0215; F04C 27/00

(57) ABSTRACT

A scroll compressor for compressing a fluid, the scroll compressor has a compressor housing with fluid inlet and outlet openings, a scroll carrier fixed to the housing, having a housing-fixed scroll, and a movable scroll carrier with a movable scroll. In order to compress the fluid, a fluid flow duct leads from the fluid inlet opening through intermediate spaces between the scrolls to the fluid outlet opening and a first seal receiving groove with a first spiral seal arranged therein and having a first sealing surface is formed in the movable scroll, and a second seal receiving groove with a second spiral seal arranged therein and having a second sealing surface is formed in the scroll which is fixed to the housing. Pressurization lines open in each case on a side of the respective spiral seal opposite the respective sealing surface into the respective seal receiving groove.

### CROSS-REFERENCE TO RELATED APPLICATIONS

This application is a 371 Natioal Phase of International Application No. PCT/AT 2022/000014, filed Oct. 25, 2022, which is incorporated herein by reference as if fully set forth.

### TECHNICAL FIELD

The invention relates to a scroll compressor for compressing a fluid, in particular a gas, wherein the scroll compressor has a compressor housing with a fluid inlet opening and a fluid outlet opening, and a scroll carrier, which is fixed to the housing and has a scroll, which is fixed to the housing, is arranged in a fixed position in the compressor housing, and a movable scroll carrier with a movable scroll is movably arranged in the compressor housing, and the movable scroll is drivable by means of an eccentric of the scroll compressor, wherein, in order to compress the fluid, a fluid flow duct leads from the fluid inlet opening through intermediate spaces between the scrolls to the fluid outlet opening and, in an end face of the movable scroll that faces away from the movable scroll carrier, a first seal receiving groove with a first spiral seal arranged therein is formed, wherein the movable scroll abuts with a first sealing surface of the first spiral seal against the scroll carrier, which is fixed to the housing, and, in an end face of the scroll, which is fixed to the housing, which end face faces away from the scroll carrier, which is fixed to the housing, a second seal receiving groove with a second spiral seal arranged therein is formed, wherein the scroll, which is fixed to the housing, abuts with a second sealing surface of the second spiral seal against the movable scroll carrier, and wherein first pressurization lines lead from the intermediate spaces through the movable scroll into the first seal receiving groove and second pressurization lines lead from the intermediate spaces through the scroll, which is fixed to the housing, into the second seal receiving groove.

### BACKGROUND

Such scroll compressors are known in the prior art. They are also frequently referred to as spiral compressors. CN 109058111 A discloses prior art of the type in question. In this document, the pressurization line opens in each case laterally into the seal receiving groove. In this document, whether or not the pressurization line is covered by the spiral seal depends on the position of the spiral seal in the seal receiving groove.

### SUMMARY

It is the object of the invention to improve a scroll compressor of the type mentioned at the beginning.

For this purpose, the invention provides that the first pressurization lines open on a side of the first spiral seal opposite the first sealing surface into the first seal receiving groove and the second pressurization lines open on a side of the second spiral seal opposite the second sealing surface into the second seal receiving groove.

A substantial advantage of the fact that the respective pressurization lines open on the side of the respective spiral seal opposite the respective sealing surface into the respective seal receiving groove is that the spiral seal can be pressurized on its side opposite the sealing surface via the respective pressurization line, irrespective of its position in the seal receiving groove. In contrast to the prior art mentioned at the beginning, it is not possible for the respective spiral seal to cover or close the respective pressurization line in such a way that pressurization via the pressurization line is prevented. A further advantage of the invention is that the respective spiral seal can be installed preloaded in the respective seal receiving groove, even in the idle state. In addition, the invention permits the spiral seal also to be automatically readjusted over its entire life cycle in the event of wear, since it is always ensured that the respective spiral seal can be pressurized on the side opposite the respective sealing surface.

Preferably, the respective pressurization line opens at its end opposite the respective seal receiving groove in the region of a side wall of the respective scroll, which side wall faces an intermediate space between the scrolls and is arranged between the respective end face of the respective scroll and the respective scroll carrier of the respective scroll. This applies both to the movable scroll with its movable scroll carrier and the end face facing away from the movable scroll carrier and also to the first seal receiving groove arranged there, and to the scroll, which is fixed to the housing, with the scroll carrier, which is fixed to the housing, and the end face facing away from the scroll carrier, which is fixed to the housing, and the second seal receiving groove arranged there.

Scroll compressors according to the invention may also be referred to as spiral compressors. They are primarily used for compressing gas, with the term gas also including mixtures of different gases. The fluid to be compressed by means of the scroll compressor according to the invention may, however, also be a medium which has both gaseous and liquid phases. Trans-critical carbon dioxide may be mentioned as an example of this.

Preferred variants of the invention make provision that the first pressurization lines are each designed as at least one bore in the movable scroll and the second pressurization lines are each designed as at least one bore in the scroll, which is fixed to the housing.

It is also advantageous if the first pressurization lines and the second pressurization lines each have an angled, preferably an L-shaped, profile. In particular, this may be a profile angled at an orthogonal angle.

In principle, provision may be made that the respective pressurization lines have the same diameter on both sides of the angled portion. However, provision may also be made that the first pressurization lines and the second pressurization lines each have a different diameter on one side of an angled portion in their profile than on an opposite side. One possible embodiment makes provision, for example, that the first pressurization lines and the second pressurization lines each have a larger diameter in their profile on one side of an angled portion facing the respective intermediate space than on an opposite side.

In order to move the movable scroll in the desired manner, particularly preferred embodiments of the invention make provision that the scroll compressor has a connecting bolt which is mounted displaceably in a slot in the scroll carrier, which is fixed to the housing, and is mounted displaceably in a slot in the movable scroll carrier. Provision is advantageously made in this connection that the slots, as seen in a top view, are arranged at an acute angle relative to each other. By interaction of the connecting bolt guided in the slots with the eccentric, which drives the movable scroll, it can be ensured that the movable scroll is moved in orbiting fashion in the compressor housing and thus also in the scroll, which is fixed to the housing. In this case, it would therefore also be possible to refer to an orbiting scroll in the case of the movable scroll and to an orbiting scroll carrier in the case of the movable scroll carrier. The eccentric advantageously sits eccentrically on a drive shaft, which, by means of its rotation about its longitudinal axis, causes a correspondingly eccentric movement of the eccentric and thus the corresponding movement of the movable scroll. Dedicated motors of the scroll compressor, but also external motors or other drives, could be connected to said drive shaft. Of course, it would also be conceivable to drive the eccentric directly without a corresponding drive shaft.

A first group of scroll compressors according to the invention makes provision that a cover covering the respective first pressurization line is in each case arranged in the first seal receiving groove between the first spiral seal arranged therein and the first pressurization lines opening into the first seal receiving groove, and a cover covering the respective second pressurization line is in each case arranged in the second seal receiving groove between the second spiral seal arranged therein and the second pressurization lines which open into the second seal receiving groove. These covers which cover the respective pressurization line are advantageously mounted movably on or in the pressurization line, such that the pressure present in the respective pressurization line can be correspondingly transmitted via them to the corresponding spiral seal. It could also be mentioned that the covering covers are only placed onto the pressurization line or only loosely inserted into said pressurization line.

In other embodiments of the invention, however, these covering covers may also be entirely dispensed with. This is possible, for example, if the first spiral seal is designed as an insert part and is inserted into the first seal receiving groove and the second spiral seal is designed as an insert part and is inserted into the second seal receiving groove.

Alternatively, however, it is also possible that the first spiral seal is injected into the first seal receiving groove as an injection molded part or is imprinted as a 3D printed part, and/or that the second spiral seal is injected into the second seal receiving groove as an injection molded part or imprinted as a 3D printed part. In this case where the respective spiral seal is injected or imprinted into the respective sealing groove, it can be prevented by means of the covers that, during the injection molding process or 3D printing process, material of the respective spiral seal inadvertently penetrates the respective pressurization line.

Both the first spiral seal and the second spiral seal advantageously consist of a polymer or a polymer comprising a dry lubricant and/or reinforcing fibers. Examples of polymers which can be used include polyetheretherketone, polyamideimide, polyoxymethylene, polyketone, polyamide or polyethyleneterephthalate. Examples of dry lubricants which can be used include polytetrafluoroethylene or molybdenum disulfite. Examples of suitable reinforcing fibers include glass fibers or carbon fibers.

The scroll carrier, which is fixed to the housing, with the scroll, which is fixed to the housing, and the movable scroll carrier with the movable scroll and the various components of the compressor housing can preferably each have a main body made of an aluminum alloy or of cast iron. Preferably, a coating is applied to said main body. The coating may be, for example, a nickel-phosphorus layer, an aluminum-oxide layer or a dry-film lubricating layer. A combination of at least two of these layers is also possible. These coatings can be applied directly to the respective main body. However, it is also possible for there to be an open-pore adhesive layer, to which the coating is then applied, on the main body.

In the case of a main body made of an aluminum alloy, the adhesive layer may be, for example, an open-pore aluminum-oxide layer, such as anodized aluminum or compressed hard anodized aluminum. Another variant of a substrate or adhesive layer consists in an open-pore, plasma-chemically oxidized aluminum layer. In the case of main bodies made of cast iron, the substrates or adhesive layers may be formed, for example, by phosphating or sandblasting.

Provided it does not distort the meaning, the terms “one” or “a” used here are also to be understood in the sense of “at least one”. The designations “first” and “second” in the terms of the seal receiving groove, the spiral seal, the sealing surface and the pressurization line, etc., are used purely for the purpose of differentiation and otherwise have no deeper meaning. They could also be used in reverse.

### BRIEF DESCRIPTION OF THE DRAWINGS

Further features and details of preferred embodiments of the invention are explained by way of example in the following description of the figures on the basis of various embodiment variants of the invention. In the figures:

FIGS. 1 to 22 show illustrations of a first exemplary embodiment of a scroll compressor according to the invention; and

FIGS. 23 to 29 show illustrations of a second exemplary embodiment of a scroll compressor according to the invention.

### DETAILED DESCRIPTION

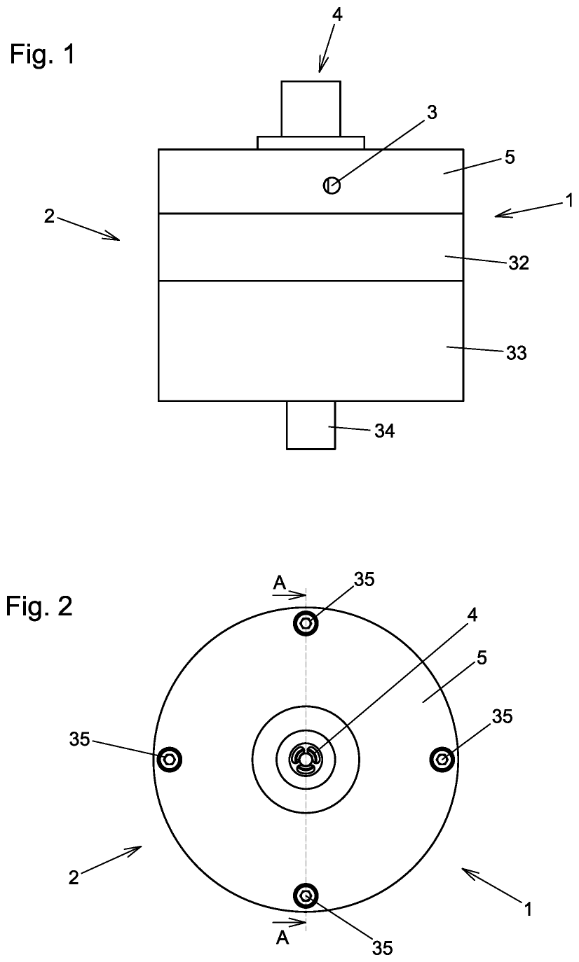

FIG. 1 shows the first exemplary embodiment of a scroll compressor 1 according to the invention in a side view of the compressor housing 2, which is composed of three housing parts 5, 32 and 33 here in this example. In both embodiments, the scroll carrier, which is fixed to the housing, is integrated in the housing part 5, and therefore for said housing part the scroll carrier 5, which is fixed to the housing, will be referred to from now on. The scroll carrier 5, which is fixed to the housing, could be manufactured with the scroll 6, which is fixed to the housing, but also as an initially separate part and then arranged in a fixed position in the compressor housing 2.

The drive shaft 34 protrudes from the compressor housing 2 on the underside. Any rotary drive, such as an electric motor or the like, can be connected to said drive shaft 34 in order to move the movable scroll carrier 7 with the movable scroll 8 within the compressor housing 2 in the manner described further below in more detail.

The fluid inlet opening 3 in the region of the scroll carrier 5, which is fixed to the housing, and the fluid outlet opening 4 leading out of the compressor housing 2 at the top are also seen in FIG. 1.

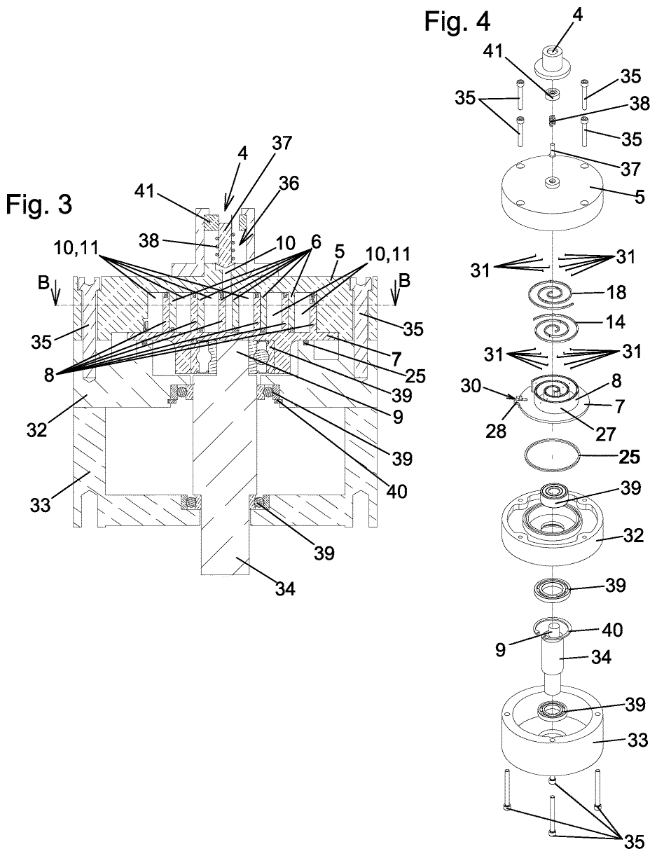

FIG. 2 shows a top view of the scroll compressor 1 of this first exemplary embodiment. In addition to the parts already mentioned, the screws 35 with which the scroll carrier 5, which is fixed to the housing, is fastened to the housing part 32 are also seen here. In addition, the intersecting line A-A is shown in FIG. 2. The vertical section along said intersecting line A-A through the scroll compressor 1 according to FIG. 2 is seen in FIG. 3.

Looking at FIG. 3, the scroll carrier 5, which is fixed to the housing, is seen there with the scroll 6, which is fixed to the housing. Both are arranged in a fixed position in the compressor housing 2. The movable scroll carrier 7 with the movable scroll 8 is also seen. These two parts are movably arranged in the compressor housing 2. In this exemplary embodiment, the movable scroll 8 is drivable together with the movable scroll carrier 7 by means of an eccentric 9. This eccentric 9 sits eccentrically on the drive shaft 34. The drive shaft 34 is guided through both the housing part 32 and through the housing part 33 and is rotatably mounted there with corresponding bearings 39, which are designed here as ball bearings. The snap ring 40 holds one of the bearings 39 in the housing part 32.

The eccentric 9 engages in the movable scroll carrier 7 by means of a bearing 39, which is also designed here as a ball bearing. The movable scroll carrier 7 is arranged together with the movable scroll 8 in a corresponding clearance of both the housing part 32 and the scroll carrier 5, which is fixed to the housing, and is movably mounted there by means of the eccentric 9 or the drive shaft 34. The sealing ring 25 provides a corresponding seal against the housing part 32.

In order to compress the fluid, a fluid flow duct 10 leads from the fluid inlet opening 3 through intermediate spaces 11 between the scrolls 6 and 8 to the fluid outlet opening 4 arranged centrally above the scroll carrier 5, which is fixed to the housing.

In preferred embodiments, as shown here, in the region of the fluid outlet opening 4 there is a pressure relief valve 36, which opens only when the fluid compressed between the scrolls 6 and 8 is under a correspondingly high pressure. If the pressure relief valve 36 is open, the correspondingly compressed fluid can flow out via the fluid outlet opening 4.

Specifically, said pressure relief valve 36 in this exemplary embodiment has a closure pin 37, which can correspondingly close the fluid flow duct 10. Said closure pin 37 is supported by means of a compression spring 38 on the support body 41 fixedly connected to the compressor housing 2. The compression spring 38 preloads the closure pin 37 in the direction of the closing position of the pressure relief valve 36. By selection of an appropriate compression spring 38, the pressure threshold value, from which the pressure relief valve 36 opens, can be set. Of course, pressure relief valves 36 designed in some other way could also be used at this juncture. The variant shown here is of course only one example.

A first seal receiving groove 13 with a first spiral seal 14 arranged therein is located in the end face 12 of the movable scroll 8, which end face faces away from the movable scroll carrier 7. The movable scroll 8 abuts with a first sealing surface 15 of the first spiral seal 14 against the scroll carrier 5, which is fixed to the housing. The movable scroll carrier 7 of this first exemplary embodiment is shown separately in FIG. 19.

A second seal receiving groove 17 with a second spiral seal 18 arranged therein is formed in an end face 16 of the scroll 6, which is fixed to the housing, which end face faces away from the scroll carrier 5, which is fixed to the housing. The scroll 6, which is fixed to the housing, abuts with a second sealing surface 19 of the second spiral seal 18 against the movable scroll carrier 7. The scroll carrier 5, which is fixed to the housing, of this first exemplary embodiment is shown separately in FIG. 9. The spiral seals 14 and 18 with their sealing surfaces 15 and 19 ensure corresponding sealing of the respective scrolls 6 and 8 against the respective other scroll carriers 5 and 7.

In order to press the spiral seals 14 and 18 with their respective sealing surfaces 15 and 19 against the corresponding scroll carriers 5 and 7, pressure is applied to them from the intermediate spaces 11. For this purpose, first pressurization lines 20 lead from the intermediate spaces 11 through the movable scroll 8 into the first seal receiving groove 13. Second pressurization lines 21 lead correspondingly from the intermediate spaces 11 through the scroll 6, which is fixed to the housing, into the second seal receiving groove 17. According to the invention, it is provided that the first pressurization lines 20 open on a side of the first spiral seal 14 opposite the first sealing surface 15 into the first seal receiving groove 13 and the second pressurization lines 21 open on a side of the second spiral seal 18 opposite the second sealing surface 19 into the second seal receiving groove 17.

The profile of the pressurization lines 20 and 21 will be explained in detail further below.

FIG. 4 shows an exploded illustration of the individual parts of the scroll compressor 1 of this first exemplary embodiment.

In order to compress the fluid, the movable scroll 8 with the movable scroll carrier 7 carries out an orbiting movement in a manner known per se in the prior art, which is caused by the interaction of the movement of the eccentric 9 with the connection, also described further below, of the movable scroll carrier 7 via the connecting bolt 28 to the scroll carrier 5, which is fixed to the housing. By means of this orbiting movement of the movable scroll 8, the intermediate spaces 11 between the scroll 6, which is fixed to the housing, and the movable scroll 8 are continuously changed such that fluid drawn in via the fluid inlet opening 3 is transported along the fluid flow duct 10 in the intermediate spaces 11 between the scrolls 6 and 8 and simultaneously compressed, and therefore it can flow in the compressed state out of the fluid outlet opening 4 from the central region between the scrolls 6 and 8 when the pressure relief valve 36 is correspondingly open.

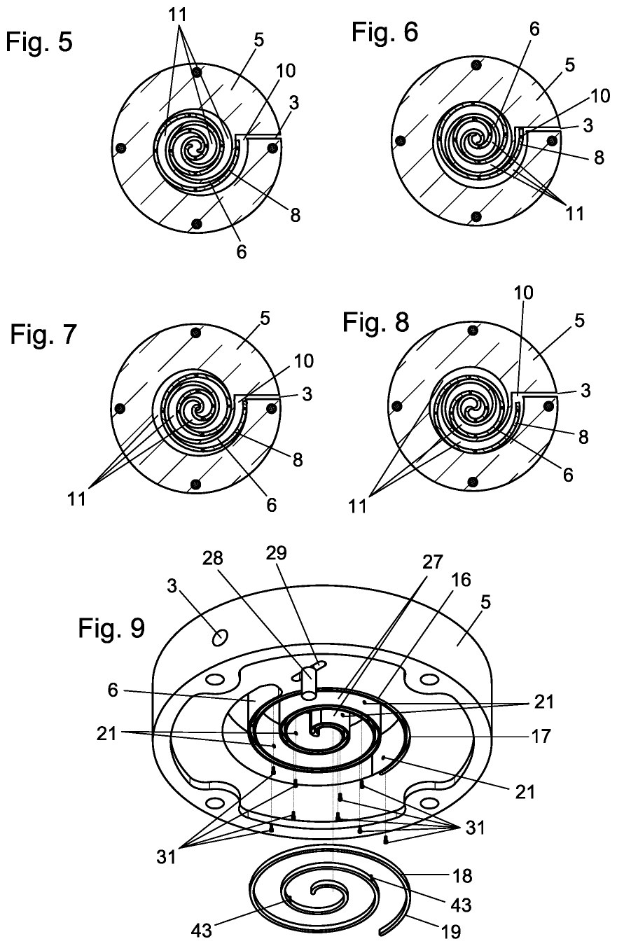

FIGS. 5 to 8 each show horizontal sections through the scroll carrier 5, which is fixed to the housing, and the scrolls 6 and 8 along the intersecting line B-B from FIG. 3, wherein FIGS. 5 to 8 show different relative positions between the scrolls 6 and 8 in the form of snapshots of the orbiting movement. Since this type of compression of fluids by means of corresponding scroll compressors 1 is known per se, this does not need to be explained further.

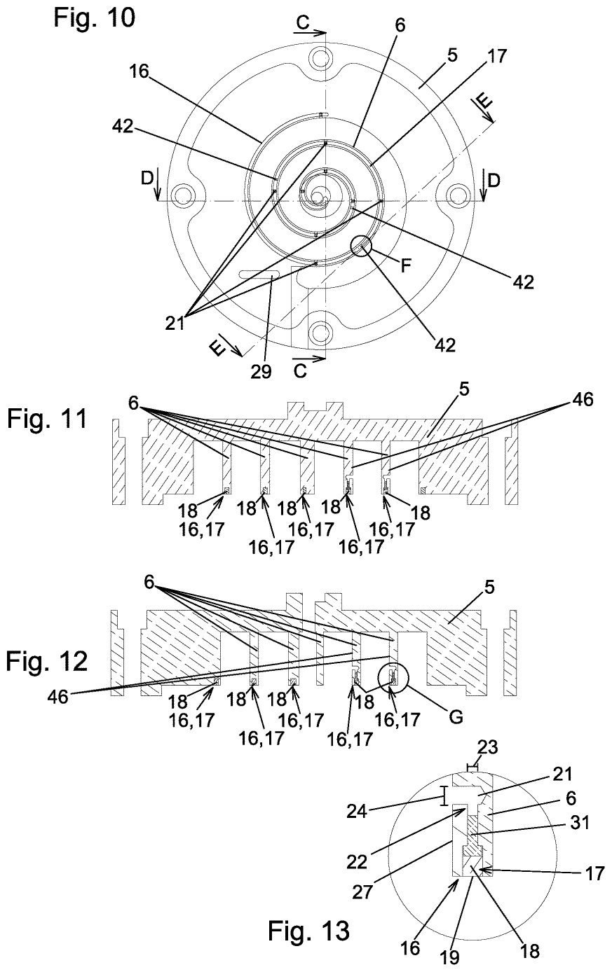

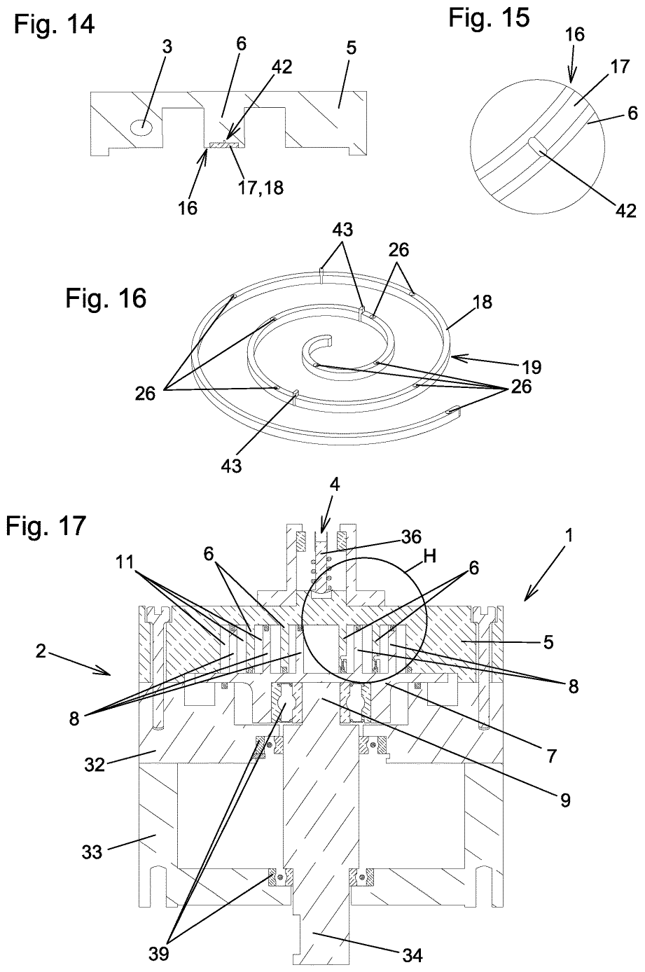

FIGS. 9 to 15 now show different illustrations of the scroll carrier 5, which is fixed to the housing, with the scroll, which is fixed to the housing, and the first spiral seal 14 of this first exemplary embodiment. FIG. 9 shows a perspective view obliquely from below of the scroll carrier 5, which is fixed to the housing, wherein the second spiral seal 18 and also the cover 31, also explained further below, are shown in exploded form detached from the scroll carrier 5, which is fixed to the housing. FIG. 10 shows a view from below of the scroll carrier 5, which is fixed to the housing. FIG. 11 shows the section along the intersecting line C-C from FIG. 10, FIG. 12 shows the section along the intersecting line D-D from FIG. 10, FIG. 13 shows the region G from FIG. 12 in enlarged form, and FIG. 14 shows a section along the intersecting line E-E from FIG. 10. FIG. 15 shows the detail F from FIG. 10 in enlarged form, and FIG. 16 shows a view of the second spiral seal 18 detached from the scroll carrier 5, which is fixed to the housing.

It is readily seen in the sections along the intersecting lines C-C and D-D in FIGS. 11 and 12 how the second spiral seal 18 is arranged in the second seal receiving groove 17 of the scroll 6, which is fixed to the housing. The second sealing surface 19 of the second spiral seal 18 faces out of the second seal receiving groove 17, and therefore it can sealingly abut against the movable scroll carrier 7 in the manner already illustrated in FIG. 3. FIG. 13 shows in enlarged form how the second pressurization line 21 opens on a side of the second spiral seal 18 opposite the second sealing surface 19 into the second seal receiving groove 17. In this first exemplary embodiment, a cover 31 of mushroom-shaped design here is arranged in the region of said opening, the cover covering the second pressurization line 21 and resting movably thereon, such that the cover 31 transmits the pressure acting thereon in the pressurization line 21 to the second spiral seal 18 in order to press the latter with its sealing surface 19 against the movable scroll carrier 7. With its end opposite the second spiral seal 18, the second pressurization line 21 opens in the region of a side wall 27 of the scroll 6, which is fixed to the housing, into one of the intermediate spaces 11, so that pressure from the intermediate space 11 can act on the second spiral seal 18 in the manner described through the second pressurization line 21 via the cover 31. The pressurization line 21 thus serves to use the pressure from the intermediate space 11 for pressing the spiral seal 18 with its second sealing surface 19 against the movable scroll carrier 7. The side wall 27, into which the second pressurization line 21 opens, is located between the end face 16 of the scroll 6, which is fixed to the housing, and the scroll carrier 5, which is fixed to the housing.

This example illustrated here shows that the second pressurization line 21 can be in the form of bores in the scroll 6, which is fixed to the housing; see in particular FIG. 13. In the example specifically shown here, the pressurization line 21 is formed from two bores opening into each other. Said bores are arranged with respect to each other in such a way that the pressurization line 21 here in this example has an angled profile. The angled portion 22 forms a right angle. It is thus also possible to refer to a pressurization line 21 with an L-shaped profile, as can be readily seen in FIG. 13.

It can also be readily seen in FIG. 13 that the pressurization line 21 can have a different diameter on one side of the angled portion 22 than on an opposite side. This can be readily seen in FIG. 13 by way of the two diameters 23 and 24. In this exemplary embodiment, it is provided that the pressurization line 21 has a larger diameter 24 on the side of the angled portion 22 facing the intermediate space 11 than on the opposite side.

FIG. 16 shows a perspective top view obliquely from above of the side of the second spiral seal 18 opposite the second sealing surface 19, with which the latter is inserted into the second seal receiving groove 17. The gripping points 26 for the covers 31 of this exemplary embodiment can be seen here. In addition, the separating bodies 43, which serve to divide the pressurized intermediate space between the second seal receiving groove 17 and the second spiral seal 18 into regions separated from one another in terms of pressure, are seen. For this purpose, the separating bodies 43 engage in the separating body receptacles 42, illustrated in FIGS. 14 and 15, in the scroll 6, which is fixed to the housing. In this exemplary embodiment, the separating bodies 43 are integrally formed on the second spiral seal 18. A solution the other way around, in which corresponding separating body receptacles are formed on the second spiral seal 18 and the separating bodies are in the form of protrusions in the second seal receiving groove 17, is, of course, also conceivable.

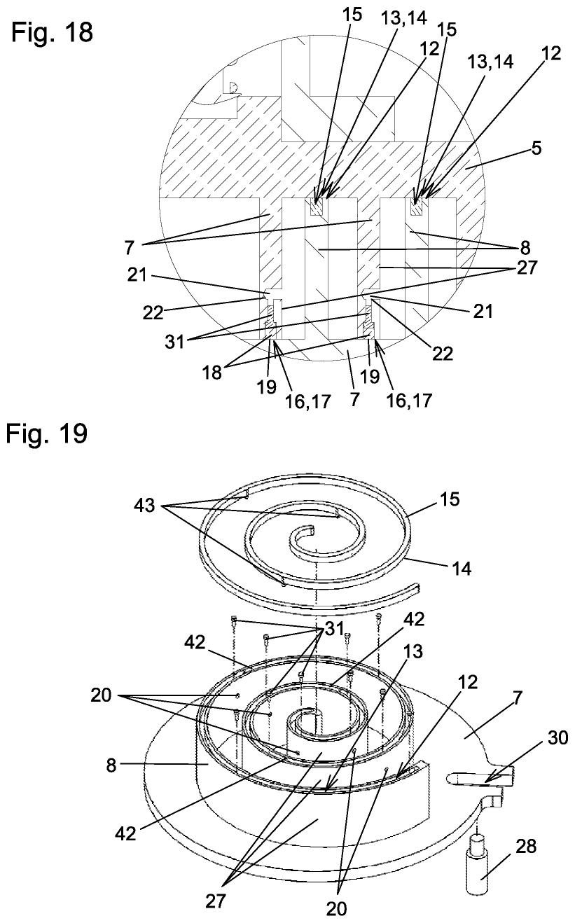

FIG. 17 shows a sectional view of the first exemplary embodiment analogously to FIG. 3. The region H from FIG. 17 is shown in FIG. 18. Here, it can be seen once again how the scroll 6, which is fixed to the housing, is sealed against the movable scroll carrier 7 by means of the second spiral seal 18 and its second sealing surfaces 19. In addition, FIG. 18 also shows how the movable scroll 8 sealingly abuts with the first spiral seal 14, which is arranged in the first seal receiving groove 13 in the end face 12, and its first sealing surface 15 against the scroll carrier 5, which is fixed to the housing.

In an analogous illustration to FIG. 9, FIG. 19 now shows the movable scroll carrier 7 with the movable scroll 8 and the first seal receiving groove 13, which is formed in the end face 12 of said scroll. The first spiral seal 14 arranged there and the covers 31 are shown in turn in exploded form in FIG. 19 in a manner raised out of the first seal receiving groove 13. Corresponding separating bodies 43 are in turn formed on the first spiral seal 14 and in turn engage in corresponding separating body receptacles 42 of the first seal receiving groove 13, with the same technical effect as has been described above with regard to the second spiral seal 18 and to the second seal receiving groove 17. The design of the first pressurization line 20 and its technical effect of pressurizing the first spiral seal 14 via the covers 31 also corresponds to how this has been implemented in case of the scroll 6, which is fixed to the housing, and has been explained on the basis of FIGS. 9 to 15, and therefore, in order to avoid repetition, reference is made in analogy to that described above. In FIG. 19, the slot 30 in the movable scroll carrier 7, in which the connecting bolt 28 is displaceably mounted, can also be seen.

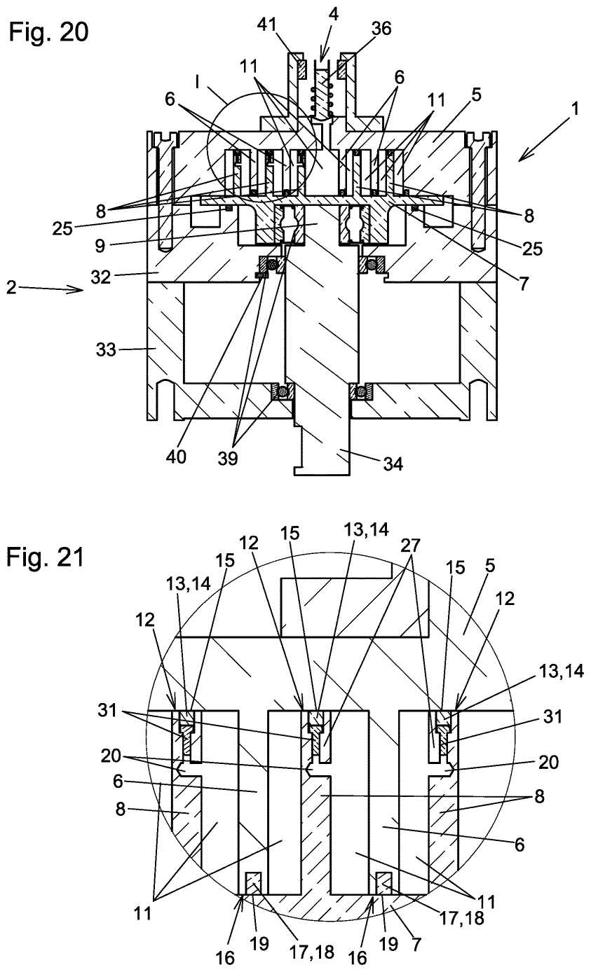

FIG. 20 shows a section analogous to FIG. 3 through the first exemplary embodiment, and FIG. 21 shows the region I from FIG. 20 in enlarged form. In FIG. 21 it can once again readily be seen how the first spiral seal 14, which is arranged in the end faces 12 of the movable scroll 8 in the first seal receiving groove 13 provided there, sealingly abuts with its first sealing surfaces 15 against the scroll carrier 5, which is fixed to the housing. For all of the details, what has been previously stated with regard to the scroll 6, which is fixed to the housing, with its second seal receiving groove 17 and the second spiral seal 18 arranged therein and the second pressurization line 21, can be applied analogously in the case of the movable scroll 8.

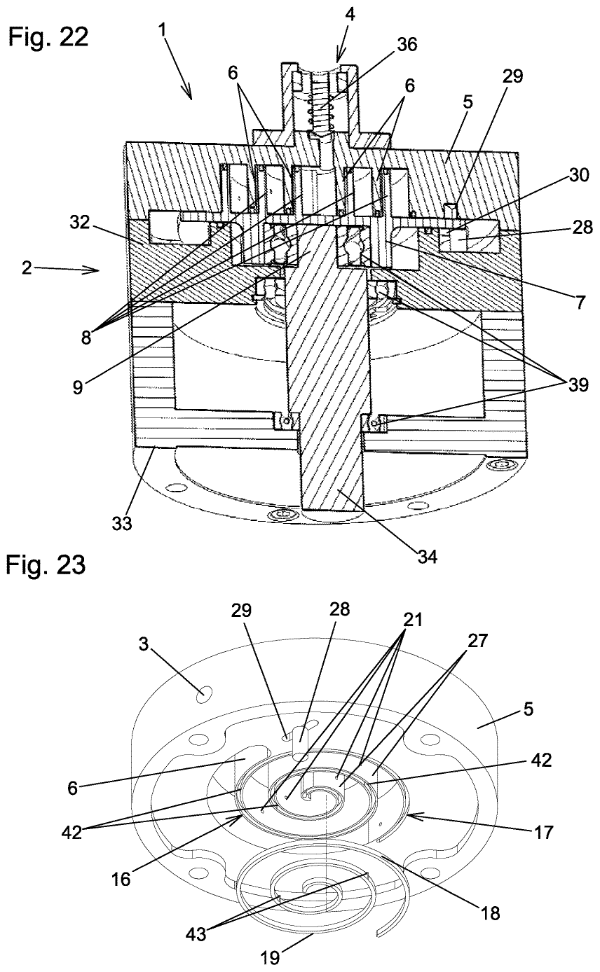

In the perspectively illustrated section through the first exemplary embodiment of the scroll compressor 1 according to FIG. 22, it can be seen how the connecting bolt 28 is displaceably mounted both in the slot 29 of the scroll carrier 5, which is fixed to the housing, and in the slot 30 of the movable scroll carrier 7. By the interaction of said displaceable mounting of the common connecting bolt 28 in the two slots 30 and 29 with the eccentric mounting of the movable scroll carrier 7 on the eccentric 9 and with the corresponding rotation of the drive shaft 34, the desired orbiting movement of the movable scroll 8 is produced. During this movement, the connecting bolt 28 is displaced both in the slot 29, that is, in the scroll carrier 5, which is fixed to the housing, and in the slot 30, that is, in the movable scroll carrier 7.

As seen in a top view, the slots 29 and 30 are arranged at an acute angle relative to each other.

With reference to FIGS. 23 to 29, a second exemplary embodiment according to the invention of a scroll compressor 1 will now be explained below. This largely corresponds to the first exemplary embodiment, and therefore only the differences with regard to the first exemplary embodiment will be discussed. Otherwise, reference is made to the above descriptions regarding the first exemplary embodiment.

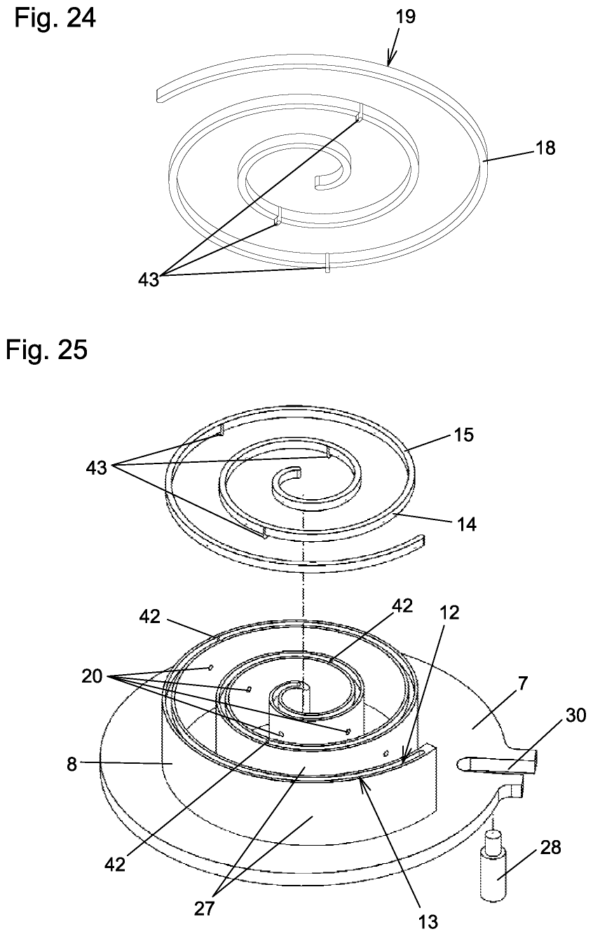

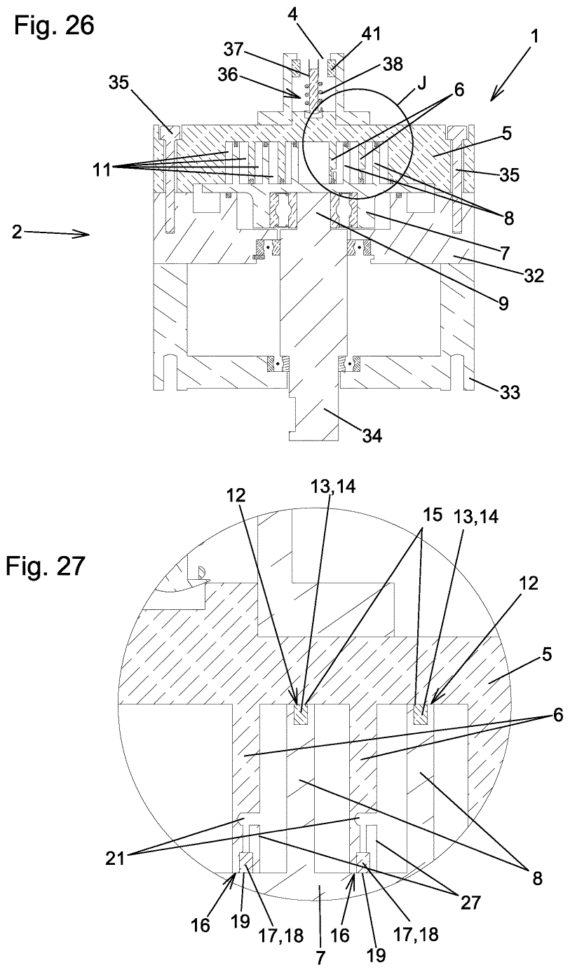

A first essential difference between the first and the second exemplary embodiment of the invention is that, in the second exemplary embodiment according to FIGS. 23 to 29, there are no covers 31. In this second exemplary embodiment, the pressure transmitted from the intermediate spaces 11 via the first pressurization line 20 and the second pressurization line 21 therefore acts directly on the first spiral seal 14 and the second spiral seal 18, in order to press them with their first and second sealing surfaces 15 and 19 against the corresponding scroll carriers 5 and 7. FIG. 23 in turn shows a view of the scroll carrier 5, which is fixed to the housing, of this second exemplary embodiment, the second spiral seal 18 being shown detached from the second seal receiving groove 17. FIG. 24 shows the second spiral seal 18 of this second exemplary embodiment in a perspective view of the side opposite the second sealing surface 19. Since there are no covers 31 in this exemplary embodiment, there are also no gripping points 26 on the second spiral seal 18. The same applies to the first spiral seal 14 shown together with the movable scroll carrier 7 and the movable scroll 8 of this second exemplary embodiment. FIG. 26 shows a corresponding vertical section through the scroll compressor 1 of this second exemplary embodiment. The enlarged region J from FIG. 26 is shown in FIG. 27. Here, it can readily be seen how the second spiral seal 18 is arranged in the second seal receiving groove 17 of the scroll 6, which is fixed to the housing, and sealingly abuts with its sealing surface 19 against the movable scroll carrier 7. It can also be readily seen in FIG. 27 how the second pressurization line 21 of this exemplary embodiment leads directly to the side of the second spiral seal 18 opposite the second sealing surface 19.

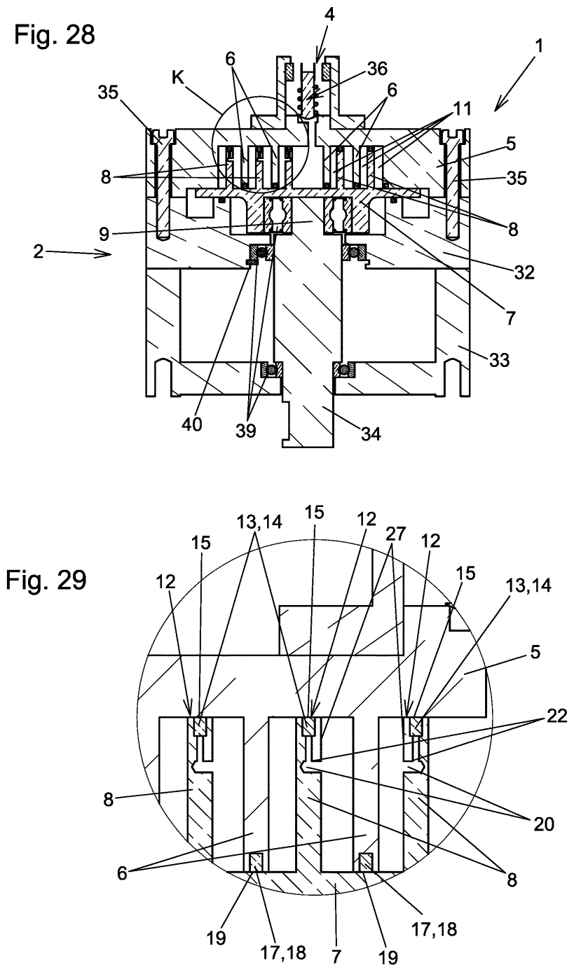

FIG. 28 once again shows a longitudinal section through the second exemplary embodiment of the scroll compressor 1. The region K marked there is shown in enlarged form in FIG. 29. Here, it is seen how the first spiral seal 14, which is arranged in the end faces 12 of the movable scroll 8 in the first seal receiving groove 13, sealingly abuts with its first sealing surface 15 against the scroll carrier 5, which is fixed to the housing. Here, too, as stated, the covers 31 are absent, and therefore the pressure transmitted from the intermediate spaces 11 via the first pressurization line 20 in each case acts directly on the side of the first spiral seal 14 opposite the first sealing surface 15.

The spiral seals 14 and 18 of this second exemplary embodiment are preferably insert parts, which are initially manufactured separately and then inserted into the corresponding seal receiving grooves 13 and 17.

In the first exemplary embodiment of the scroll compressor according to the invention according to FIGS. 1 to 22, the spiral seals 14 and 18 may also be such insert parts. In this first exemplary embodiment, however, it is also possible, because of the covers 31, to realize the spiral seals 14 and 18 as injection molded parts or as 3D printed parts by injecting or imprinting them directly into the respective seal receiving grooves 13 and 17.

### KEY TO THE REFERENCE SIGNS

1 Scroll compressor
2 Compressor housing
3 Fluid inlet opening
4 Fluid outlet opening
5 Scroll carrier, which is fixed to the housing
6 Scroll, which is fixed to the housing
7 Movable scroll carrier
8 Movable scroll
9 Eccentric
10 Fluid flow duct
11 Intermediate space
12 End face
13 First seal receiving groove
14 First spiral seal
15 First sealing surface
16 End face
17 Second seal receiving groove
18 Second spiral seal
19 Second sealing surface
20 First pressurization line
21 Second pressurization line
22 Angled portion
23 Diameter
24 Diameter
25 Sealing ring
26 Gripping point
27 Side wall
28 Connecting bolt
29 Slot
30 Slot
31 Cover
32 Housing part
33 Housing part
34 Drive shaft
35 Screw
36 Pressure relief valve
37 Closure pin
38 Compression spring
39 Bearing
40 Snap ring
41 Support body
42 Separating body receptacle
43 Separating body

1. A scroll compressor for compressing a fluid, the scroll compressor comprising:
a compressor housing with a fluid inlet opening and a fluid outlet opening;
a scroll carrier, which is fixed to the housing and has a fixed scroll, which is fixed to the housing, arranged in a fixed position in the compressor housing;
a movable scroll carrier with a movable scroll is movably arranged in the compressor housing, and the movable scroll is drivable by an eccentric of the scroll compressor;
wherein, in order to compress the fluid, a fluid flow duct leads from the fluid inlet opening through intermediate spaces between the fixed and movable scrolls to the fluid outlet opening; and,
in an end face of the movable scroll that faces away from the movable scroll carrier, a first seal receiving groove with a first spiral seal arranged therein is formed, wherein the movable scroll abuts with a first sealing surface of the first spiral seal against the scroll carrier which is fixed to the housing; and,
in an end face of the scroll, which is fixed to the housing, which end face faces away from the scroll carrier, which is fixed to the housing, a second seal receiving groove with a second spiral seal arranged therein is formed;
wherein the scroll, which is fixed to the housing, abuts with a second sealing surface of the second spiral seal against the movable scroll carrier;
first pressurization lines lead from the intermediate spaces through the movable scroll into the first seal receiving groove and second pressurization lines lead from the intermediate spaces through the scroll, which is fixed to the housing, into the second seal receiving groove; and
wherein the first pressurization lines open on a side of the first spiral seal opposite the first sealing surface into the first seal receiving groove and the second pressurization lines open on a side of the second spiral seal opposite the second sealing surface into the second seal receiving groove.

2. The scroll compressor as claimed in claim 1, wherein the first pressurization lines each comprise at least one bore in the movable scroll and the second pressurization lines each comprise at least one bore in the scroll, which is fixed to the housing.

3. The scroll compressor as claimed in claim 1, wherein the first pressurization lines and the second pressurization lines each have an angled profile.

4. The scroll compressor as claimed in claim 3, wherein the first pressurization lines and the second pressurization lines each have a different diameter on one side of an angled portion than on an opposite side of the respective angled profile.

5. The scroll compressor as claimed in claim 3, wherein the first pressurization lines and the second pressurization lines each have a larger diameter on one side of an angled portion thereof facing the respective intermediate space than on an opposite side.

6. The scroll compressor as claimed in claim 1, further comprising a connecting bolt, which is mounted displaceably in a slot in the scroll carrier, which is fixed to the housing, and is mounted displaceably in a slot in the movable scroll carrier.

7. The scroll compressor as claimed in claim 6, the respective slots in the scroll carrier and the movable scroll carrier, as seen in a top view, are arranged at an acute angle relative to each other.

8. The scroll compressor as claimed in claim 1, further comprising first cover covering the respective first pressurization line is in each case arranged in the first seal receiving groove between the first spiral seal arranged therein and the first pressurization lines opening into the first seal receiving groove, and a second cover covering the respective second pressurization line is in each case arranged in the second seal receiving groove between the second spiral seal arranged therein and the second pressurization lines which open into the second seal receiving groove.

9. The scroll compressor as claimed in claim 1, wherein the first spiral seal comprises a first insert part and is inserted into the first seal receiving groove and the second spiral seal comprises a second insert part and is inserted into the second seal receiving groove.

10. The scroll compressor as claimed in claim 1, wherein any the first spiral seal is injected into the first seal receiving groove as an injection molded part or is imprinted as a 3D printed part.

11. The scroll compressor as claimed in claim 1, wherein the second spiral seal is injected into the second seal receiving groove as an injection molded part or imprinted as a 3D printed part.
